(19) United States
(12) Patent Application Publication
(10) Pub. No.: US 2009/0048937 A1
(43) Pub. Date: Feb. 19, 2009

(54) SYSTEM AND METHODS FOR PURCHASE MANAGEMENT FOR CUSTOM PRODUCTS

(75) Inventors: Pablo Contreras, Stillwater, MN (US); David Lease, Stillwater, MN (US); Arnold Castro, Stillwater, MN (US)

Correspondence Address: CONLEY ROSE, P.C.;David A. Rose, P. O. BOX 3267, HOUSTON, TX, 77253-3267, US

(73) Assignee: ENTOGY LLC, Stillwater, MN (US)

(21) Appl. No.: 11/839,635

(22) Filed: Aug. 16, 2007

(51) Int. Cl. G06Q 30/00

(52) U.S. Cl. 705/26

(57) ABSTRACT

In at least some disclosed embodiments, a method includes receiving customer information regarding a custom product from a customer; generating a quotation for the custom product based on 1) the customer information, 2) dealer information, and 3) fabricator information; selling the customer the custom product in a sale based on the quotation; and communicating the sale to the customer, a dealer, and a fabricator. The dealer and the fabricator are associated with the custom product, and all elements of the method are performed in a network-based system.

### REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Network-based systems, such as the internet, are efficient tools when shopping for well-defined products. Such systems allow for rapid transactions with minimal information exchange at any time of day or night. For such products, options are not usually customizable, and research, installation, and trial periods are usually unnecessary. As such, the price of these products can be well defined as well. Consequently, the human element can be efficiently displaced for transactions involving these products because no expertise is necessary to guide the customer through the purchase. However, even the internet has not maximized its potential in the case of custom products, where multiple parties are involved in the sale, many options are customizable, and the customer's needs are highly specific. Furthermore, these factors cause prices of custom products to vary considerably, another hindrance to network-based systems. As such, custom product transactions still require the expertise of a human guide with years of experience in the field, someone with “know-how.” A system or method that combines network-based efficiency with human know-how in custom product transactions would be advantageous.

### SUMMARY OF THE INVENTION

In at least some disclosed embodiments, a method includes receiving customer information regarding a custom product from a customer; generating a quotation for the custom product based on 1) the customer information, 2) dealer information, and 3) fabricator information; selling the customer the custom product in a sale based on the quotation; and communicating the sale to the customer, a dealer, and a fabricator. The dealer and the fabricator are associated with the custom product, and all elements of the method are performed in a network-based system.

In other disclosed embodiments, a system includes a server; a customer interface coupled to the server via internet; a dealer interface coupled to the server via the internet; and a fabricator interface coupled to the server via the internet. The customer interface presents a quotation for a custom product to a customer based on 1) customer information entered by the customer via the customer interface; 2) dealer information entered by a dealer via the dealer interface; and 3) fabricator information entered by a fabricator via the fabricator interface. A dealer and a fabricator are associated with the custom product.

In yet other disclosed embodiments, a method includes entering customer information regarding a custom product into a customer interface; and receiving a quotation for the custom product based on 1) the customer information, 2) dealer information, and 3) fabricator information. A dealer and a fabricator are associated with the custom product, all elements of the method are performed in a network-based system, and the dealer information and the fabricator information are updated in real-time.

In further disclosed embodiments, a method includes entering dealer information regarding a custom product into a dealer interface, and receiving a purchase transaction of a sale of the custom product via the dealer interface. The dealer information is updated in real time, and a quotation for the custom product is generated based partially on the dealer information. The sale is based on the quotation, and all elements of the method are performed in a network-based system.

In even further disclosed embodiments, a method includes entering fabricator information regarding a custom product into a fabricator interface, and receiving an order for the custom product via the fabricator interface. The fabricator information is updated in real time, and a quotation for the custom product is generated based partially on the fabricator information. The order is based on a sale of the custom product, and the sale is based on the quotation. All elements of the method are performed in a network-based system.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description of the drawings, taken in connection with the accompanying drawings and detailed description, wherein like reference numerals represent like parts.

FIG. 1 is a block diagram illustrating various interfaces in accordance with some embodiments of the present disclosure;

FIG. 2 is a flow chart illustrating a method for custom product purchase management in accordance with some embodiments of the present disclosure;

FIG. 3 is a flow chart illustrating another method for purchasing a custom product accordance with some embodiments of the present disclosure; and

FIG. 4 illustrates an exemplary general purpose computer system suitable for implementing some embodiments of the present disclosure.

### DETAILED DESCRIPTION

It should be understood at the outset that although an illustrative implementation of one embodiment of the present disclosure is illustrated below, the present system may be implemented using any number of techniques, whether currently known or later developed. The present disclosure should in no way be limited to the illustrative implementations, drawings, and techniques illustrated below, including the exemplary design and implementation illustrated and described herein, but may be modified within the scope of the appended claims along with their full scope of equivalents.

### I. Overview

In order for network-based systems, such as the internet, to maximize the potential to sell custom products, such systems must invade one of the few remaining spheres of human competence over machines: “know-how.” The systems will emulate behavior and store knowledge typically attributed to those with years of experience in the field. Additionally, such systems should connect all parties involved in the sale, save customer preferences, extrapolate those preferences to new products, enable the customer to realistically preview the custom product based on customer customizations before manufacture, and provide a quotation based on the preferences and customizations that is accurate enough for customer reliance.

The following disclosure is divided into five sections including this overview. Section II defines terminology used in this disclosure. Section III describes in detail a system for custom product purchase management that provides context and support for the methods disclosed in the remaining sections. Section IV describes in detail a method for custom product purchase management. Section V describes in detail a method for purchasing a custom product. Section VI describes in detail a general purpose computer implementation suitable for implementing several embodiments of the present disclosure.

### II. Terminology

As used herein, the terms “including” and “comprising” are used in an open-ended fashion, and thus should be interpreted to mean “including but not limited to”.

As used herein, the term “custom product” refers to a product that is created to meet the specifications of the individual purchasing the product, commonly for a specific space or purpose. Custom products include, for example, windows, doors, countertops, and other products ordered for particular specifications and/or use, and furniture. Custom products may necessitate services, such as special delivery or installation, beyond services common to products that are not made to order.

As used herein, the term “fabricator” refers to the entity that makes and distributes custom products for retail sale. In some circumstances, the fabricator provides services ancillary to the sale of custom products, such as special delivery or installation of the custom product. Such services may depend on the type of the custom product.

As used herein, the term “dealer” refers to the entity that offers custom products for retail sale. The dealer may, in some circumstances, manage the purchase of a custom product from the inception of the transaction, e.g. by providing research information, to order of the custom product, and may coordinate with the fabricator or a third party contractor for services ancillary to the sale of custom products, such as installation or delivery.

As used herein, the term “customer” refers to the individual or entity that purchases the custom product from the dealer.

As used herein, the term “third party contractor” refers to the entity contracted with by the dealer, fabricator, or customer to provide services ancillary to the sale of a custom product, such as installation or delivery.

As used herein, the term “real time” refers to the actual time it takes for the system to process or save input or updated information, typically a period of time short enough so as to be negligible to the customer.

As used herein, the term “abbreviated quotation” refers to a quotation that will only require the customer to provide a minimal amount of information to obtain a price. For example, such minimal information includes zip code, the size of the custom product (e.g., in square feet or linear feet), a color for the custom product, and any options requiring significant labor costs (e.g., cutting holes in counters to accommodate sinks and faucets).

As used herein, the term “detailed quotation” refers to a quotation that requires the customer to provide detailed information to obtain a price. For example, such detailed information includes size, finish, color, and any options requiring significant labor costs for each individual piece of the custom product. The customer should provide a zip code as well.

As used herein, the term “kiosk” refers to a small stand-alone device providing information and services on a screen.

As used herein, the term “confirmation” refers to a listing of the essential terms of a sale of a custom product.

As used herein, the term “purchase transaction” refers to a listing of the terms of a sale of a custom product.

As used herein, the term “order” refers to a listing of the essential terms of a of a sale of a custom product, specifications used for fabrication of the custom product, and third party contractor information associated with the sale of the custom product combined.

### III. System for Custom Product Purchase Management

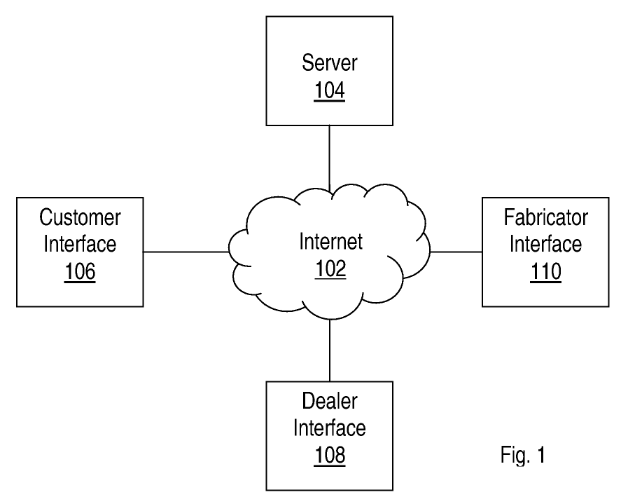

FIG. 1 is a block diagram illustrating various interfaces in accordance with some embodiments of the present disclosure. In some embodiments, a server 104 includes a computer coupled to the internet 102. In an alternative embodiment, another network-based system besides the internet 102 is used. The internet 102 couples the server 104 to interfaces 106-110. Specifically, the interfaces are a customer interface 106, a dealer interface 108, and a fabricator interface 110. In some embodiments, the customer interface 106 includes a browser in kiosks in retail stores. In some embodiments, the dealer and fabricator interfaces comprise browsers in business computers at a dealer headquarters and a fabricator headquarters respectively. In an alternative embodiment, interfaces 106-110 comprise browsers in personal computers. In an alternative embodiment, the kiosks are mobile and can be located anywhere as a result of accessing the internet wirelessly. In an alternative embodiment, the server 104 comprises multiple computers.

Browser software is normally stored on internal long-term storage media such as a hard disk. When the user initiates execution of the software, the processor loads the software into memory, and then accesses individual instructions from the software as needed for execution. Browser software normally comprises a graphical user interface (GUI) that graphically presents the user with a set of options on an output device, determines which, if any, of the available options that the user selects via an input device, and responsively presents a new set of options in accordance with the user's selection.

Conventional browser software presents the user options in the form of a web page. The browser can retrieve the web page from the server 104. Web pages are typically written in hyper-text markup language (“HTML”), a programming language that allows programmers to present options in the form of “links” from graphics or textual items within a page to other pages having new options in similar form. Some web pages comprise embedded software “applets” that the browsers can execute to accept text input, perform calculations, animate objects on the screen, and/or send information to computers.

The interfaces 106, 108, and 110 allow a customer, a dealer, and a fabricator, respectively, to enter information about custom products. The dealer and fabricator enter information about custom products offered for wholesale and retail respectively, while the customer browses the custom products and enters customization information according to the customer's needs. The information may be updated in real time. Furthermore, the information is stored by the server 104, which uses the information to provide a quotation to the customer via the customer interface 106. If the quotation is not acceptable to the customer, the customer adjusts the customer information until the quotation becomes acceptable to the customer. Because the server 104 stores information, the customer may adjust the customer information over a span of multiple visits to the customer interface 106, and may also perform research for these adjustments by browsing the dealer and fabricator information via the customer interface 106.

Once the quotation is acceptable to the customer, the custom product is sold to the customer via the customer interface 106. After such a retail sale, the server 104 communicates a confirmation of the sale to the customer via the customer interface 106, a purchase transaction of the sale to the dealer via dealer interface 108, and an order for the custom product to the fabricator via the fabricator interface 110. Thus, the server 104 acts as a broker of information between the parties to the transaction.

As such, dealer information about the custom product may include, for example, retail information about pricing, availability, partnerships, brands, materials, and third party contractors. Fabricator information may include, for example, the same type of information as dealer information, but at the wholesale level. For example, the fabricator pricing information will reflect wholesale prices rather than retail prices. Dealer and fabricator information may also include images and audio information.

The dealer and fabricator information are in a form such that the server 104 can perform customization calculations on the information. For example with regard to pricing, Dealer ABC should input that grey quartz granite countertops from Fabricator XYZ retails for twenty dollars per square foot. Thus, when the server 104 receives customer information reflecting that a customer's countertop is thirty square feet in area, the server can offer the customer a quotation wherein the cost of grey quartz granite from Fabricator XYZ for the countertop will be six hundred dollars. The dealer and fabricator information is updated in real time.

Dealer information regarding pricing can also be submitted in the form of a markup of fabricator pricing, in dollars or percentage, in order to make the process even more efficient. For example, suppose Dealer ABC decides to mark up Fabricator XYZ's grey quartz granite countertops by 400%. Dealer ABC inputs this information into the dealer interface 108. Subsequently, Fabricator XYZ updates its wholesale pricing information for grey quartz granite countertops from two dollars per square foot to four dollars per square foot via the fabricator interface 110. As a result, the server 104 automatically increases any subsequent quotations from Dealer ABC for grey quartz granite countertops made by Fabricator XYZ from ten dollars per square foot to twenty dollars per square foot. The retail price is updated without any input from Dealer ABC. A similar update would occur if Dealer ABC input a four dollar markup (rather than a percentage) on Fabricator XYZ's grey quartz granite.

Dealer ABC is not restricted to adjusting price via specific custom products, but can adjust price by any level of granularity. For example, Dealer ABC can adjust the price of all countertops simultaneously. Dealer ABC may also adjust only Fabricator XYZ's merchandise, custom products made of any type of granite, grey products used in the kitchen, etc. Such information allows the customer to browse custom products by price, or use price as one sorting element.

As an example of dealer information regarding partnership and brands, a dealer inputs, as dealer information via dealer interface 108, the various fabricators and brands with which the dealer does business. Such information allows the customer to browse custom products by fabricator or brand, or use the two as sorting elements. This type of dealer information is especially relevant if the dealer is combining products from different fabricators to sell as a single unit. In such a scenario, fabricators will not, e.g., submit an image of the combined product as fabricator information through the fabricator interface 110. Fabricators may also input partnership and brand via the fabricator interface 110 to reflect their dealings with dealers, other fabricators, and brands. Much like pricing information, updates by fabricators to partnership and brand information will automatically update dealer partnership and brand information.

Dealer information regarding materials may be provided in anticipation of research questions by the customer. For example, a customer may require a countertop that is scratch resistant and heat resistant. Because the dealer has submitted, as dealer information via the dealer interface 108, that granite from Fabricator XYZ is especially scratch resistant and heat resistant, a customer using the customer interface 106 to research this materials question would be directed to use granite from Fabricator XYZ for the customer's countertop project. In some embodiments, numerous research questions are anticipated in this manner to provide the customer with not only knowledge based on years of experience, but knowledge that is also dynamic due to the ease of updating dealer information. Topics related to materials may include, for example, makeup, advantages, disadvantages, buyers, sellers, home-use, and comparison with other materials. In some embodiments, fabricator materials information will be directed to the dealer, using vocabulary well known in the industry, as dealers are more familiar with the industry than customers. However, in an alternative embodiment, fabricator materials information is also directed to the customer.

Dealer information regarding third party contractors is also in a form such that the server 104 can perform customization calculations on the information. As an example, Dealer ABC inputs, via the dealer interface 108, that countertops from Fabricator XYZ can be installed by Installer TUV for two dollars per square foot, and can be delivered by Shipper LMN for one dollar per pound per mile. Server 104 uses this dealer information in conjunction with customer information (square feet of project, and delivery information) entered via the customer interface 106 to provide the customer a shipping and installation quotation upon which the customer can rely. As with other types of information, an update by the fabricator triggers a corresponding update to dealer information. Also, this type of dealer information allows the customer to browse custom products by shipping area, shipping price, etc., and allows the customer sort custom products via shipping area, shipping price, etc.

In some embodiments, the dealer interface 108 allows a dealer to process payments resulting from the sale of a custom product, check the status of fabrication of the custom product via communication with the fabricator interface 110, and notify the customer of completion of fabrication via communication with the customer interface 106. Furthermore, the dealer may use the dealer interface 108 to communicate with third party contractors in order to facilitate ancillary services. For example, in some embodiments, the dealer may retain a deliverer or installer for the customer. In some embodiments, the dealer may supply information about the customer and the custom product to a third party contractor previously selected by the customer.

In some embodiments, the fabricator interface 110 is used in a respective fashion. The fabricator may enter status information regarding the progress of fabrication of the custom product into the fabricator interface 110 to be communicated to the dealer and customer via the dealer interface 108 and the customer interface 106, respectively. In some embodiments, this status information includes completion of fabrication of the custom product. Furthermore, the fabricator may use the fabricator interface 110 to communicate with third party contractors in order to facilitate ancillary services. For example, in some embodiments, the fabricator may retain a deliverer or installer for the customer. In some embodiments, the fabricator may supply information about the customer and the custom product to a third party contractor previously selected by the customer.

In some embodiments, the dealer or the fabricator inspects the location of installation of the custom product and takes measurements, which the dealer or fabricator then inputs via their respective interface 108, 110 as an update to the dealer or fabricator information respectively. Such an update will automatically trigger an update to the quotation, which will be delivered to the customer for approval via the customer interface 106.

### IV. Method for Custom Product Purchase Management

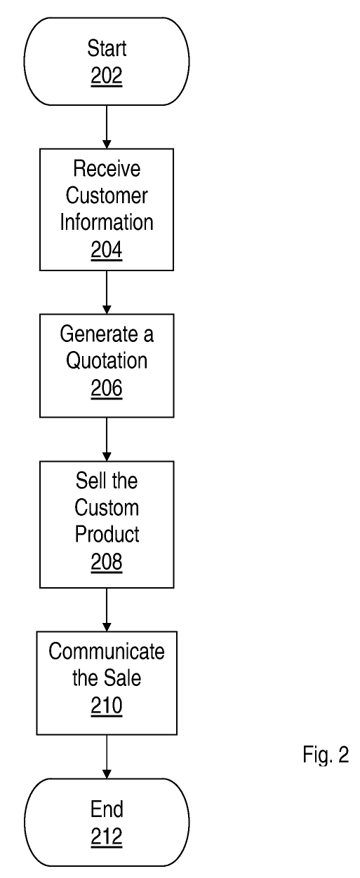

FIG. 2 is a flow chart illustrating a method of managing a custom product purchase in accordance with some embodiments of the present disclosure. After beginning at 202, customer information regarding a custom product is received at 204. The customer information is received from the customer through the customer interface 106. Initially, when no customer information is entered, potential combinations of custom products as entered by the dealer and fabricator populate a matrix of configurations presented to the customer. A customer narrows this matrix by entering customer information regarding the custom product type the customer wishes to purchase. For example, the customer may initially select “countertops” from the customer interface 106 to narrow the matrix of potential combination of custom products such that only countertops are presented. The customer may then select customizable features of the custom product to further narrow the matrix presented. For example, the customer may select “color” and “grey” to choose only from among grey countertops. Some customizable features may be pre-selected. For example, if the customer has previously purchased a grey custom product or has previously entered grey as a preference, the customer need not select “color” or “grey” to be presented with only grey countertops for selection. Note that any piece of customer information may narrow the presented matrix of potential combinations of custom products, not only custom product type and customizable features information.

In order to help the customer visualize how the customer information affects the custom product, optionally a virtual design of the custom product in a native setting may be generated. For example, a countertop corresponding to the size, shape, and color of the customer's counter, entered as customer information via the customer interface 106, is displayed in a kitchen setting. Such a virtual design system is especially helpful when the customer desires to preview how multiple custom products interact aesthetically. For example, after selecting customizations for countertops, faucets, and mirrors, a business customer may preview the multiple custom products together in a men's room setting before purchasing them. Once the customizing and previewing end, a selection of a custom product from the remaining elements in the matrix is received for quotation.

Next, a quotation for the custom product is generated at 206. The quotation is based on the customer information, dealer information, and fabricator information, and is communicated to the customer via the customer interface 106. The customer information used to generate the quotation may be the newly received information in 204, information stored and loaded from a previous visit, or a combination of both. In any event, the newly received customer information is stored for future visits. In some embodiments, the dealer and fabricator information used to generate the quotation are updated in real time, and are also used to generate the quotation. The quotation may be an abbreviated quotation or a detailed quotation depending on which option the customer has selected. An abbreviated quotation requires the customer to provide only minimal information to receive a quotation, while a detailed quotation allows the customer to specify any options available for each individual piece of the custom product. Also multiple quotations for a plurality of possible combinations may be generated for simultaneous comparison.

Next, the custom product is sold, in some embodiments, by the customer selecting a quotation and accepting the quotation's terms 208. After such a sale, a confirmation of the sale is communicated to the customer via the customer interface 106, a purchase transaction of the sale is communicated to the dealer via dealer interface 108, and an order for the custom product is communicated to the fabricator via the fabricator interface 110 before the end is reached at 212. In some embodiments, the method described is performed over the internet. In an alternative embodiment, another network-based system is used.

### V. Method for Purchasing a Custom Product

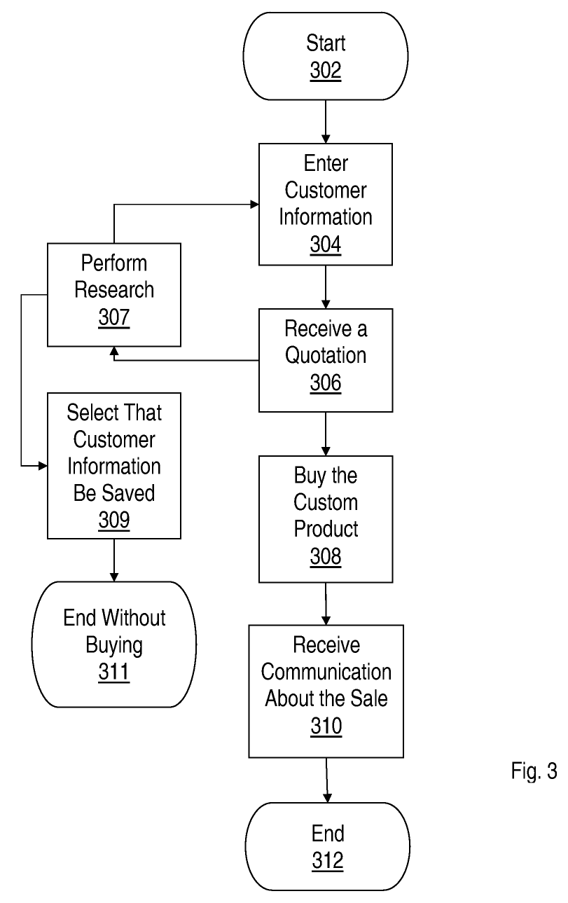

FIG. 3 is a flow chart illustrating a method for purchasing a custom product in accordance with some embodiments of the present disclosure. In some embodiments, the internet 102 is used for communication. In an alternative embodiment, another network-based system other than the internet 102 is used. After beginning at 302, a customer enters customer information at 304. The customer information may include information about the customer, custom product type, customizable features, quotations, and preferences. If a customer has any customer information saved from a previous project, preferences information, or both, such information may be loaded for the customer automatically.

A customer submits, as customer information 304 via the customer interface 106, contact information such as the customer's name, email address, delivery information, customer interface information (e.g., username, password), and payment information (e.g., credit card, credit line, pay in store).

A customer submits, as customer information 304 via the customer interface 106, custom product type information. Custom product type information comprises broadly what the custom product is. For example, windows, doors, countertops, furniture, faucets, etc., are custom product types.

After selecting a custom product type, the customer submits, as customer information 304 via the customer interface 106, customizable features information. Customizable features comprise material, shape, size, location, color, accent, finish, and quantity of the custom product.

The customer submits, as customer information 304 via the customer interface 106, quotation information. Quotation information comprises decisions on whether the customer would prefer a detailed quotation, an abbreviated quotation, multiple quotations, simultaneous quotations, etc.

The customer submits, as customer information 304 via the customer interface 106, preferences information. For example, the customer may wish to only select from grey colored custom products in future visits. As another example, the customer may wish to only select from Fabricator XYZ's products in future visits. Such information may not only be entered explicitly, but may be deduced implicitly by the server 104 as well.

Initially, when no customer information is entered, potential combinations of custom products as entered by the dealer and fabricator populate a matrix of configurations presented to the customer. A customer narrows this matrix of possibilities by entering customer information. For example, if the customer enters a request to deliver the custom product to a certain state, the matrix narrows to reflect only custom products from fabricators or third party contractors willing to deliver to that state. Narrowing the possibilities available in the matrix occurs despite the customer not having yet entered any custom product type or customizable features information.

Some customizable features may be pre-selected. For example, if the customer has previously purchased a grey custom product or has previously entered grey as a preference, the customer need not select “color” or “grey” to be presented with only grey countertops for selection. Once the customer is finished customizing the custom product, the customer selects the custom product from the remaining elements in the matrix for quotation.

The customer may save the customer information entered at any time, load this customer information on any subsequent visits to the customer interface 106, and save any new customer information entered regarding the custom product. Thus, the customer may research a custom product using the customer interface 106, and make adjustments to the customer information before purchasing the custom product.

Next, the customer receives a quotation at 306 via the customer interface 106. This quotation is in the form specified by the customer, e.g., an abbreviated quotation. The quotation is not only based on customer information, but dealer and fabricator information as well. For example, if Fabricator XYZ will not have grey granite in stock for two months, and has entered such information via the fabricator interface 110, a quotation for a grey granite countertop from Fabricator XYZ will reflect this fact in the estimated delivery date. As another example, if Dealer ABC is offering a discount on all custom products from Fabricator XYZ, and has entered such information via the dealer interface 108, a quotation for any custom product from Fabricator XYZ will reflect this fact in the price. Fabricator and dealer information are updated in real time.

In some embodiments, if the customer is not satisfied with the quotation, the customer may perform research at 307 in order to know which pieces of customer information should be adjusted at 304 to obtain a satisfactory quotation at 306. At 309 and 311, in some embodiments the customer selects to save any information the customer has submitted, and terminate the current session without purchasing the custom product, so that the customer may return later and resume the customization and purchase process from the point of save.

Next, the customer purchases the custom product based on the quotation at 308 by, in some embodiments, selecting and accepting the terms of one quotation. Finally, the customer receives a confirmation of sale via the customer interface at 310 before the method ends at 312. Examples of the confirmation may include a printable page display, email, phone message, or letter.

### VI. General Purpose Computer Implementation

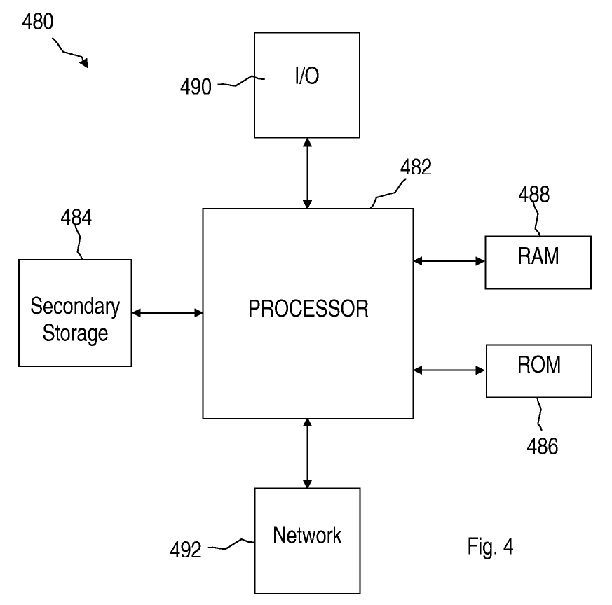

The system described above may be implemented on any general-purpose computer with sufficient processing power, memory resources, and network throughput capability to handle the necessary workload placed upon it. FIG. 4 illustrates a typical, general-purpose computer system suitable for implementing one or more embodiments disclosed herein. The computer system 480 comprises a processor 482 (which may be referred to as a central processor unit or CPU) that is in communication with memory devices including secondary storage 484, read only memory (ROM) 486, random access memory (RAM) 488, input/output (I/O) 490 devices, and network connectivity devices 492. The processor may be implemented as one or more CPU chips.

The secondary storage 484 is typically comprised of one or more disk drives or tape drives and is used for non-volatile storage of data and as an over-flow data storage device if RAM 488 is not large enough to hold all working data. Secondary storage 484 may be used to store programs which are loaded into RAM 488 when such programs are selected for execution. The ROM 486 is used to store instructions and perhaps data which are read during program execution. ROM 486 is a non-volatile memory device which typically has a small memory capacity relative to the larger memory capacity of secondary storage. The RAM 488 is used to store volatile data and perhaps to store instructions. Access to both ROM 486 and RAM 488 is typically faster than to secondary storage 484.

I/O 490 devices may comprise printers, video monitors, liquid crystal displays (LCDs), touch screen displays, keyboards, keypads, switches, dials, mice, track balls, voice recognizers, card readers, paper tape readers, or other well-known input devices. The network connectivity devices 492 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 492 devices may enable the processor 482 to communicate with an internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave.

Such information, which may comprise data or instructions to be executed using processor 482 for example, may be received from and outputted to the network, for example, in the form of a computer data baseband signal or signal embodied in a carrier wave. The baseband signal or signal embodied in the carrier wave generated by the network connectivity 492 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 482 executes instructions, codes, computer programs, scripts which it accesses from hard disk, floppy disk, optical disk (these various disk based systems may all be considered secondary storage 484), ROM 486, RAM 488, or the network connectivity devices 492.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method comprising:
receiving customer information regarding a custom product from a customer;
generating a quotation for the custom product based on 1) the customer information, 2) dealer information, and 3) fabricator information;
selling the customer the custom product in a sale based on the quotation; and
communicating the sale to the customer, a dealer, and a fabricator,
wherein the dealer and the fabricator are associated with the custom product; and
wherein all elements of the method are performed in a network-based system.

2. The method of claim 1, further comprising:
receiving dealer information about the custom product from the dealer; and
storing the dealer information.

3. The method of claim 1, further comprising:
receiving fabricator information about the custom product from the fabricator; and
storing the fabricator information.

4. The method of claim 1, further comprising:
updating the dealer information and the fabricator information in real time.

5. The method of claim 1, further comprising:
generating a virtual design comprising the custom product, the virtual design based on the customer information.

6. The method of claim 1, wherein receiving customer information regarding a custom product from a customer further comprises:
loading customer information previously received; and
storing customer information newly received.

7. The method of claim 1, wherein generating a quotation for the custom product based on 1) the customer information, 2) dealer information, and 3) fabricator information comprises:
generating an abbreviated quotation for the custom product based on 1) the customer information, 2) dealer information, and 3) fabricator information.

8. The method of claim 1, wherein generating a quotation for the custom product based on 1) the customer information, 2) dealer information, and 3) fabricator information comprises:
generating a detailed quotation for the custom product based on 1) the customer information, 2) dealer information, and 3) fabricator information.

9. The method of claim 1, wherein generating a quotation for the custom product based on 1) the customer information, 2) dealer information, and 3) fabricator information comprises:
generating multiple quotations for the custom product based on 1) the customer information, 2) dealer information, and 3) fabricator information comprises;
presenting for selection the multiple quotations; and
receiving selection of a quotation out of the multiple quotations.

10. The method of claim 1, wherein receiving customer information regarding a custom product from a customer further comprises:
generating a matrix of configurations of the custom product based on 1) the customer information, 2) dealer information, and 3) fabricator information; and
presenting for selection one or more configurations of the custom product from the matrix of configurations.

11. The method of claim 10, further comprising:
receiving selection of the custom product from among the one or more configurations.

12. The method of claim 10, wherein presenting for selection one or more configurations of the custom product from the matrix of configurations comprises:
presenting for selection a first customizable feature of the custom product currently available from the dealer and fabricator.

13. The method of claim 12, further comprising:
pre-selecting a second customizable feature, based on 1) the customer information, 2) the dealer information, and 3) the fabricator information, such that the second customizable feature is not presented for selection.

14. A system comprising:
a server;
a customer interface coupled to the server via internet;
a dealer interface coupled to the server via the internet; and
a fabricator interface coupled to the server via the internet,
wherein the customer interface presents a quotation for a custom product to a customer based on:
customer information entered by the customer via the customer interface;
dealer information entered by a dealer via the dealer interface; and
fabricator information entered by a fabricator via the fabricator interface; and
wherein the dealer and the fabricator are associated with the custom product.

15. The system of claim 14, wherein the dealer information and the fabricator information are entered via the dealer interface and fabricator interface respectively, and
wherein the dealer information and the fabricator information are updated in real time.

16. The system of claim 14, wherein the server communicates a confirmation of a sale of the custom product to the customer via the customer interface.

17. The system of claim 14 wherein the server communicates a purchase transaction of a sale of the custom product to the dealer via the dealer interface.

18. The system of claim 14, wherein the server communicates an order for the custom product, based on a sale of the custom product, to the fabricator via the fabricator interface.

19. The system of claim 14, wherein the server stores the customer information, the dealer information, and the fabricator information for later use.

20. The system of claim 14, wherein the customer interface is a browser in a mobile kiosk.

21. The system of claim 14, wherein the customer interface is a browser in a stationary kiosk in a retail store.

22. The system of claim 14, wherein the customer interface is the customer's personal computer.

23. A method comprising:
entering customer information regarding a custom product into a customer interface; and
receiving a quotation for the custom product based on 1) the customer information, 2) dealer information, and 3) fabricator information,
wherein a dealer and a fabricator are associated with the custom product;
wherein all elements of the method are performed in a network-based system; and
wherein the dealer information and the fabricator information are updated in real-time.

24. The method of claim 23, further comprising:
buying the custom product in a sale based on the quotation; and
receiving a communication about the sale via the customer interface

25. The method of claim 23, wherein entering customer information regarding a custom product into a customer interface further comprises:
selecting one of an abbreviated quotation and a detailed quotation.

26. The method of claim 23, wherein receiving a quotation for the custom product based on 1) the customer information, 2) dealer information, and 3) fabricator information comprises:
receiving multiple quotations for the custom product based on 1) the customer information, 2) dealer information, and 3) fabricator information;
selecting a quotation out of the multiple quotations.

27. The method of claim 23, wherein entering customer information regarding a custom product into a customer interface comprises:
entering customer information regarding a custom product into a customer interface over the span of multiple visits to the customer interface.

28. The method of claim 23, wherein entering customer information regarding a custom product into a customer interface further comprises:
selecting the custom product from a matrix of one or more configurations of the custom product, the matrix of one or more configurations of the custom product based on 1) the customer information, 2) dealer information, and 3) fabricator information.

29. The method of claim 28, wherein selecting the custom product from a matrix of one or more configurations of the custom product comprises:
selecting a first customizable feature of the custom product currently available from the dealer and the fabricator.

30. The method of claim 29, further comprising:
skipping selection of a second customizable feature by confirming pre-selection of the second customizable feature, pre-selection based on 1) the customer information, 2) the dealer information, and 3) the fabricator information.

31. A method comprising:
entering dealer information regarding a custom product into a dealer interface, the dealer information updated in real time, a quotation for the custom product generated based partially on the dealer information; and
receiving a purchase transaction of a sale of the custom product via the dealer interface, the sale based on the quotation;
wherein all elements of the method are performed in a network-based system.

32. The method of claim 31, wherein entering dealer information regarding a custom product into a dealer interface, the dealer information updated in real time, a quotation for the custom product generated based partially on the dealer information comprises:
entering dealer information regarding a custom product into a dealer interface, the dealer information updated in real time, a quotation for the custom product generated based partially on the dealer information, the quotation further based on customer information and fabricator information.

33. The method of claim 31, wherein entering dealer information regarding a custom product into a dealer interface, the dealer information updated in real time, a quotation for the custom product generated based partially on the dealer information comprises:
entering dealer information regarding a custom product into a dealer interface, the dealer information updated in real time, a quotation for the custom product generated based partially on the dealer information, the quotation one of an abbreviated quotation or a detailed quotation.

34. The method of claim 31, further comprising:
processing payment corresponding to the sale.

35. The method of claim 31, further comprising:
checking the status of fabrication of the custom product via the dealer interface.

36. The method of claim 31, further comprising:
notifying a customer of completion of fabrication of the custom product via the dealer interface.

37. The method of claim 36, further comprising updating the dealer information based on measurement of a location of installation of the custom product such that the quotation is automatically updated and delivered to the customer for approval.

38. A method comprising:
entering fabricator information regarding a custom product into a fabricator interface, the fabricator information updated in real time, a quotation for the custom product generated based partially on the fabricator information; and
receiving an order for the custom product via the fabricator interface, the order based on a sale of the custom product, the sale based on the quotation;
wherein all elements of the method are performed in a network-based system.

39. The method of claim 38, wherein entering fabricator information regarding a custom product into a fabricator interface, the fabricator information updated in real time, a quotation for the custom product generated based partially on the fabricator information comprises:
entering fabricator information regarding a custom product into a fabricator interface, the fabricator information updated in real time, a quotation for the custom product generated based partially on the fabricator information, the quotation further based on customer information and dealer information.

40. The method of claim 38, wherein entering fabricator information regarding a custom product into a fabricator interface, the fabricator information updated in real time, a quotation for the custom product generated based partially on the fabricator information comprises:
entering fabricator information regarding a custom product into a fabricator interface, the fabricator information updated in real time, a quotation for the custom product generated based partially on the fabricator information, the quotation one of an abbreviated quotation or a detailed quotation.

41. The method of claim 38, further comprising:
entering status information into the fabricator interface regarding fabrication of the custom product.

42. The method of claim 38, further comprising:
notifying a dealer, corresponding to the sale, and a customer, corresponding to the sale, of completion of fabrication of the custom product.

43. The method of claim 42, further comprising updating the fabricator information based on measurement of a location of installation of the custom product such that the quotation is automatically updated and delivered to the customer for approval.
